(19) United States
(12) Patent Application Publication
(10) Pub. No.: US 2019/0011616 A1
(43) Pub. Date: Jan. 10, 2019

(54) LIGHT ABSORPTION PRIVACY FILM

(71) Applicant: HEWLETT-PACKARD DEVELOPMENT COMPANY, L.P., HOUSTON, TX (US)

(72) Inventors: KUAN-TING WU, TAIPEI CITY (TW); WEI KUANG CHU, TAIPEI CITY (TW); CHARLIE KU, TAIPEI CITY (TW)

(21) Appl. No.: 16/067,756

(22) PCT Filed: Mar. 1, 2016
(86) PCT No.: PCT/US2016/020208

§ 371 Date: Jul. 2, 2018

(51) Int. Cl. G02B 5/20; G06F 21/84

(52) U.S. Cl. CPC G02B 5/208; G06F 21/84

(57) ABSTRACT

Example implementations relate to a light absorption privacy film. For example, a privacy film may include privacy gates that at least partially block content displayed by a display panel when the privacy film is adjacent to the display panel. The privacy film may also include light absorption material to absorb light from the content.

### BACKGROUND

A computing device may include and/or may be in communication with a display device that allows a user to view content. Some display devices may be a touch screen display device that allows a user to provide touch inputs. For example, a user may use their finger and/or a stylus pen to provide touch inputs on the screen in order to manipulate the content on the screen.

### BRIEF DESCRIPTION OF THE DRAWINGS

Some examples of the present application are described with respect to the following figures:

FIG. 1 is a block diagram of an example privacy film to provide privacy and to absorb light;

FIG. 2 is a block diagram of an example display device that includes a privacy film to provide privacy and to absorb light; and

FIG. 3 is a block diagram of an example display device that includes a permanent privacy film to provide privacy and to absorb light.

### DETAILED DESCRIPTION

As described above, a computing device may include and/or may be in communication with a display device that allows a user to view content. Examples of these devices include smartphones, tablets, laptops, monitors, and the like. Because the use of such devices has become prevalent, protecting a user's privacy while using these devices has become a concern. Additionally, prolonged use of these display devices may cause health issues for a user, such as discomfort to the user's eyes, eye damage and/or disease, premature aging of the eye, and the like.

Examples discussed herein provide techniques for providing privacy and ultraviolet (UV) and/or blue light absorption through the use of a light absorption privacy film. For example, a privacy film may include privacy gates to at least partially block content displayed by a display panel of a display device when the privacy film is adjacent to the display panel. The privacy film may also include light absorption material to absorb light (e.g., UV light and/or blue light) that may be emitted from the content. In some examples, the light absorption material may be included, contained within, and/or part of each of the privacy gates in the privacy film. In other examples, the light absorption material may surround the privacy gates in the privacy film.

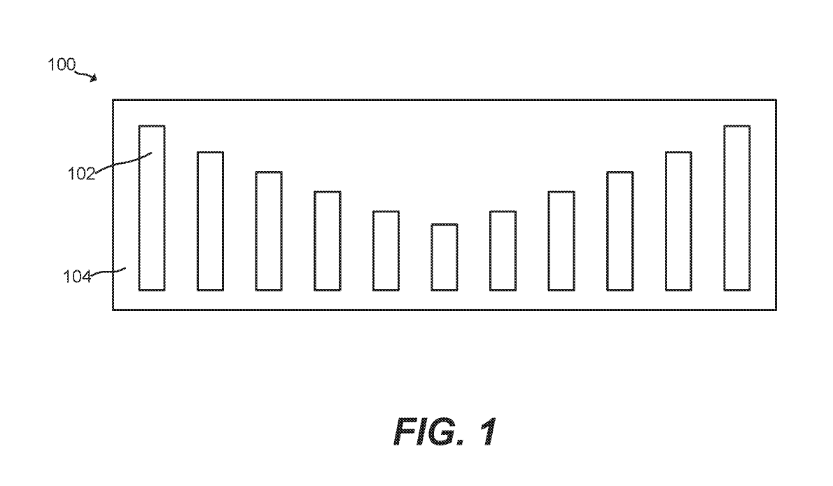

Referring now to the figures, FIG. 1 is a block diagram of an example privacy film 100 to provide privacy and to absorb light. The exterior of the privacy film 100 may be made of any suitable material. In some examples, the exterior of the privacy film 100 may be a plastic substrate, such as a polyacrylic, a poly (methyl methacrylate) (PMMA), a polycarbonate, cyclic olefin copolymer (COC), polyethylene terephthalate (PET), and the like.

The privacy film 100 includes any suitable number of privacy gates 102. The privacy gates 102 may be made of any suitable material capable of at least partially blocking content that may be displayed by a display panel of a display device when the privacy film 100 is adjacent to the display panel. The privacy gates 102 may have any suitable gradient level and/or density (e.g., number of privacy gates 102) to control the degree to which content is blocked and/or displayed through the privacy gates 102.

In some examples, the plurality of privacy gates 102 may each be angled at a particular angle with respect to a surface of the privacy film 102, where the particular angle may determine the amount of content to be displayed through and/or blocked by the privacy gates 102.

The privacy film 100 also includes area 104, which is the area surrounding the privacy gates 102. The area 104 may allow the content from the display panel of the display device to be at least partially displayed through the privacy gates 102.

The privacy film 100 may also include light absorption material to absorb light from the content displayed by the display panel of the display device. The light absorption material may be any suitable material to absorb UV and/or blue light, such as transparent and/or semi-transparent blue light absorbers, UV absorbers, and the like. Examples of transparent and/or semi-transparent blue light absorbers include iron oxide, NiTiO₃, lutein, lead sulfochromate yellow, lead antimonite yellow, lead-tin-antimony yellow, diarylide, arylide, bisacetoacetarylide, benzimidazolone, and the like. Examples of UV absorbers include benzophenones, anthranilates, dibenzoylmethanes, PABA derivatives, salicylates, cinnamates, camphor derivatives (e.g., 290-400 nm), and the like. The degree of UV and/or blue light absorption may be controlled by the density of the light absorption material. In some examples, the light absorption material is within each of the privacy gates 102. In other examples, the light absorption material surrounds the privacy gates 102 (e.g., within area 104).

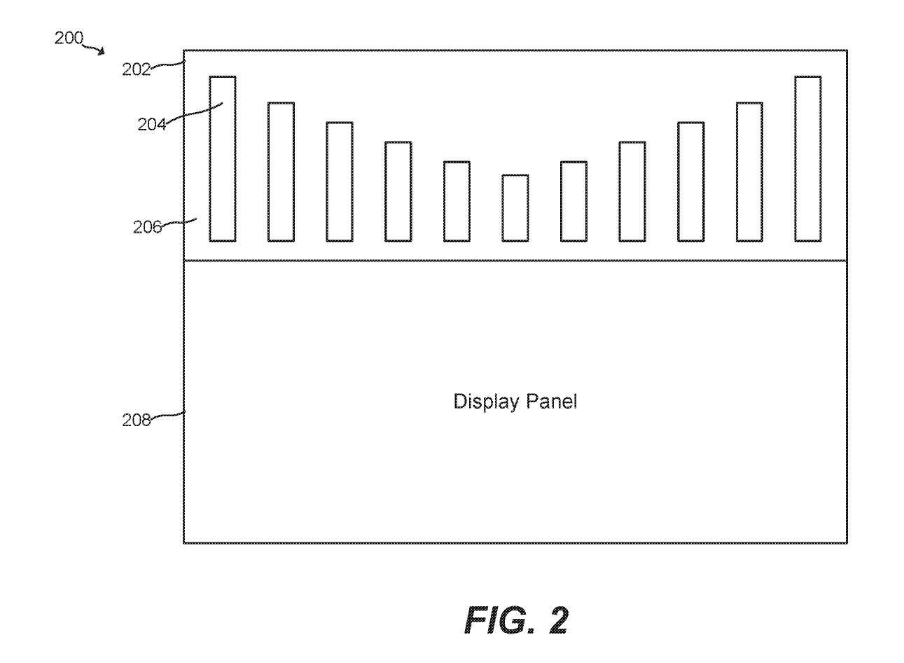

FIG. 2 is a block diagram of an example display device 200 that includes a privacy film 202 to provide privacy and to absorb light. The privacy film 202 may be similar to the privacy film 100 of FIG. 1.

The display device 200 may also include, a display panel 208 to display content. The display panel 208 may be any suitable type of display panel, such as a liquid crystal display (LCD), an organic light emitting diode (OLED) display, a polymer light emitting diode (PLED) display, a plasma display, bi-stable display (e.g., a cholesteric display, a cholesteric LCD, a micro-electromechanical system (MEMS)-based display, an electronic ink display, etc.), and the like.

The privacy film 202 of FIG. 2 may be adjacent to (e.g., next to, touching, etc.) the display panel 208 and may include any suitable number of privacy gates 204 (e.g., similar to the privacy gates 102 of FIG. 1) as well as light absorption material. The privacy film 202 may also include area 206 that surrounds the privacy gates 204, similar to the area 104 of FIG. 1. The light absorption material in the privacy film 202 may be within each of the privacy gates 204 or surrounding the privacy gates 204 (e.g., in area 206).

In some examples, the privacy film 202 may be permanently affixed to the display panel 208 (e.g., using an adhesive). In other examples, the privacy film 202 may be removable from the display panel 208.

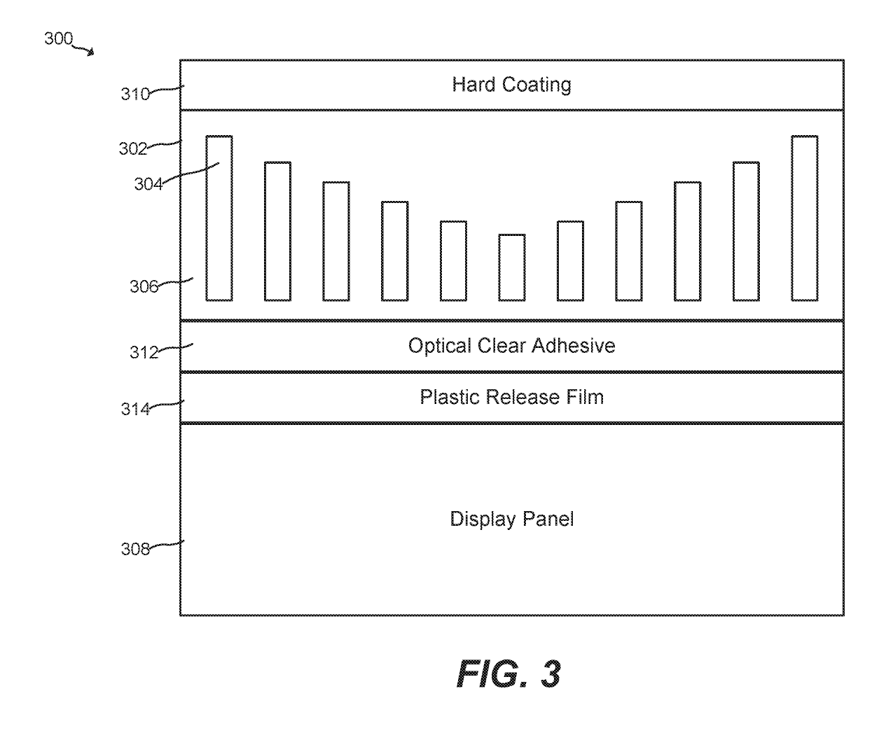

FIG. 3 is a block diagram of an example display device 300 that includes a permanent privacy film 302 to provide privacy and to absorb light. The privacy film 302 is similar to the privacy film 100 of FIG. 1 and the privacy film 202 of FIG. 2.

The display device 300 includes a display panel 308, which is similar to the display panel 208 of FIG. 2. The privacy film 302 may be adjacent to the display panel 308 and may include any suitable number of privacy gates 304 (e.g., similar to the privacy gates 102 of FIG. 1 and the privacy gates 204 of FIG. 2). The privacy film 302 may also include light absorption material that may either be within each of the privacy gates 304 or within area 306, which is the area surrounding the privacy gates 304 (e.g., similar to the area 104 of FIG. 1 and the area 206 of FIG. 2). In some examples, the privacy gate 302 may also include a hard coating 310, which may be any suitable hard coating to protect the privacy film 302.

In the example of FIG. 3, the privacy film 302 may be permanently affixed to the display panel 308 using any suitable adhesive, such as an optical clear adhesive (OCA) 312 and/or an optical clear resin (OCR) (e.g., a polyacrylic, a PMMA, a polycarbonate, a COC, a PET, etc.).

The privacy film 302 may also include a plastic release film 314 that may be used to keep the privacy film 302 from adhering to the display panel 308. The plastic release film 314 may be made of any suitable material (e.g., a PET) and may be removed when the privacy film 302 is ready to be permanently adhered to the display panel 308.

What is claimed is:

1. A privacy film, comprising:
privacy gates to at least partially block content displayed by a display panel when the privacy film is adjacent to the display panel; and
light absorption material to absorb light from the content.

2. The privacy film of claim 1, wherein the privacy film is permanently affixed to the display panel.

3. The privacy film of claim 1, wherein the privacy film is removable from the display panel.

4. The privacy film of claim 1, wherein the light absorption material is within each of the privacy gates.

5. The privacy film of claim 1, wherein the light absorption material surrounds the privacy gates.

6. The privacy film of claim 1, wherein the light absorption material absorbs at least one of ultraviolet light and blue light.

7. A display device, comprising:
a display panel to display content; and
a privacy film adjacent to the display panel, the privacy film comprising:
privacy gates to at least partially block the content; and
light absorption material to absorb light from the content.

8. The display device of claim 7, wherein the privacy film is permanently affixed to the display panel or is removable from the display panel.

9. The display device of claim 7, wherein the light absorption material is within each of the privacy gates.

10. The display device of claim 7, wherein the light absorption material surrounds the privacy gates.

11. The display device of claim 7, wherein the light absorption material absorbs at least one of ultraviolet light and blue light.

12. A privacy film, comprising:
a plurality of privacy gates each angled at a particular angle with respect to a surface of the privacy film, the plurality of privacy gates to at least partially block content displayed by a display panel when the privacy film is adjacent to the display panel; and
light absorption material to absorb light from the content.

13. The privacy film of claim 12, wherein the privacy film is permanently affixed to the display panel or is removable from the display panel.

14. The privacy film of claim 12, wherein the light absorption material is within each of the privacy gates or wherein the light absorption material surrounds the privacy gates.

15. The privacy film of claim 12, wherein the light absorption material absorbs at least one of ultraviolet light and blue light.
